(19) United States
(12) Patent Application Publication
(10) Pub. No.: US 2017/0091101 A1
(43) Pub. Date: Mar. 30, 2017

(54) Snoop Mechanism And Snoop Filter Structure For Multi-Port Processors

(71) Applicant: MediaTek Inc., Hsinchu City (TW)

(72) Inventors: Chien-Hung Lin, Hsinchu City (TW); Tung-Yao Lee, Hsinchu County (TW)

(21) Appl. No.: 15/373,038

(22) Filed: Dec. 8, 2016

Related U.S. Application Data
(60) Provisional application No. 62/266,087, filed on Dec. 11, 2015.

(51) Int. Cl. G06F 12/0831

(52) U.S. Cl. CPC G06F 12/0831; G06F 2212/621

(57) ABSTRACT

Techniques and examples pertaining to memory coherence management with a snoop mechanism and snoop filter structure for multi-port processors are described. A method may involve receiving a request from a first processor having a first plurality of local memories and more than one snoop ports. Responsive to the request, the method may involve snooping one or more snoop ports of a second processor having a second plurality of local memories without snooping any of the more than one snoop ports of the first processor.

### CROSS REFERENCE TO RELATED PATENT APPLICATION(S)

The present disclosure claims the priority benefit of U.S. Patent Application No. 62/266,087, filed on 11 Dec. 2015, which is incorporated by reference in its entirety.

### TECHNICAL FIELD

The present disclosure is generally related to memory coherence management and, more particularly, to memory coherence management with a snoop mechanism and snoop filter structure for multi-port processors.

### BACKGROUND

Unless otherwise indicated herein, approaches described in this section are not prior art to the claims listed below and are not admitted to be prior art by inclusion in this section.

In computer technology, memory coherence refers to the consistency of shared resource data stored in multiple local memories such as caches or static random-access memories (SRAMs). When local memories of a common memory resource are maintained for coherence for central processing units (CPUs) of a multi-core or multi-processor system, problems may arise with inconsistent data in the local memories. Snooping is a technique by which address lines for access to memory locations are monitored. For multi-processor systems with shared memory, snooping-based hardware memory coherence has been a widely adopted mechanism.

In a coherent multi-processor system, there is typically one main memory and multiple local memories (e.g., one or more local memories per CPU or processor), with the value of a given memory location loaded into two or more local memories. For coherency, a local memory controller monitors a bus that connects the main memory and the multiple local memories to listen for broadcasts. On a read miss to a local memory, the read request is broadcast on the bus. For example, if one local memory has cached the data corresponding to the read address, a copy of the data is sent to the requester and the state of the local memory having the data is set to “valid”. On a local write miss, bus snooping ensures that any copy in other local memories is set to “invalid”. When writing into a local memory in state “valid”, the state of that local memory is changed to “dirty” and a broadcast is sent out to invalidate other local copies.

For most applications, however, large amount of snooping tends to result in a miss because other processors often do not have the requested cache line. Missed snoop transactions intervene the operations of snooped local memories, and tends to result in performance degradation of the entire system. Missed snoop transactions also can result in redundant power consumption.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes of a snoop mechanism and snoop filter structure for multi-port processors to avoid or mitigate issues with existing solutions.

In one aspect, a method may involve receiving a request from a first processor having a first plurality of local memories. The method may also involve snooping, responsive to the request, one or more snoop ports of a second processor having a second plurality of local memories without snooping any of one or more snoop ports of the first processor.

In another aspect, a method may involve receiving a request from a first processor having a first plurality of local memories. The method may also involve snooping, responsive to the request, one or more snoop ports of a second processor having a second plurality of local memories without snooping any of one or more snoop ports of a third processor or any of one or more snoop ports of a fourth processor. The third processor may have a third plurality of local memories and the fourth processor may have a fourth plurality of local memories. Each of the first processor, the second processor, the third processor and the fourth processor may have at least one snoop port connected to a local memory coherent interconnect circuit.

In another aspect, an apparatus may include a local memory coherent interconnect circuit and a plurality of processors including at least a first processor and a second processor. The first processor may have a first plurality of local memories and the second processor may have a second plurality of local memories. The local memory coherent interconnect circuit may maintain a record of local memory line information at a processor level by associating each of the first plurality of local memories and the second plurality of local memories to either the first processor or the second processor. The local memory coherent interconnect circuit may receive a request from the first processor. The local memory coherent interconnect circuit may also filter the request based on the record to determine whether the request pertains to one of the first plurality of local memories or one of the second plurality of local memories or none of them. The local memory coherent interconnect circuit may further perform one of the following: (1) snoop at least one of one or more snoop ports of the second processor in response to determining that the request pertains to one of the second plurality of local memories; (2) ignoring the snooping of the second processor in response to determining that the request does not pertain to any one of the second plurality of local memories, or (3) snooping at least one of one or more snoop ports of the first processor in response to determining that the request pertains to one of the first plurality of local memories.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme of snoop filtering for a multi-port multi-processor system in accordance with an implementation of the present disclosure.

FIG. 2 is a diagram of an example scheme of snooping for a multi-port multi-processor system in accordance with an implementation of the present disclosure.

FIG. 3 is a diagram of an example scheme of snooping for a multi-port multi-processor system in accordance with another implementation of the present disclosure.

FIG. 4 is a simplified block diagram of an example apparatus in accordance with an implementation of the present disclosure.

FIG. 5 is a flowchart of an example process in accordance with an implementation of the present disclosure.

FIG. 6 is a flowchart of an example process in accordance with another implementation of the present disclosure.

FIG. 7 is a diagram of snoop filtering under a conventional approach.

FIG. 8 is a diagram of snooping under a conventional approach.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under the proposed schemes, a local memory coherent interconnect circuit of the proposed snoop mechanism may group snoop ports at a processor level and snoops accordingly. Accordingly, the local memory coherent interconnect may be aware of which snoop port(s) belonging to which processor. Moreover, under the proposed schemes, a snoop filter may record local memory line information based on snoop port groups, not based on snoop ports. Furthermore, under the proposed schemes, a lookup table may be utilized for determining correlation between snoop ports from which requests are received and snoop ports to be snooped.

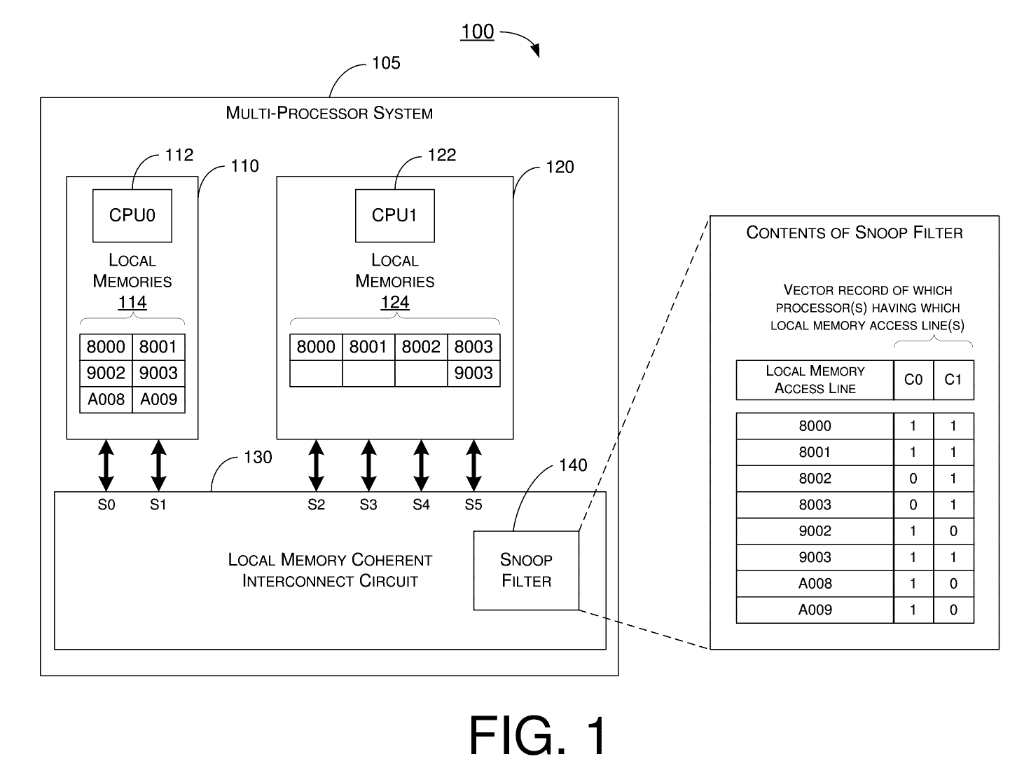

FIG. 1 illustrates an example scheme 100 of snoop filtering for a multi-port multi-processor system 105 in accordance with an implementation of the present disclosure. Multi-port multi-processor system 105 may include multiple processors, including processors 110 and 120. Each of processors 110 and 120 may be a single-core/single-central processing unit (CPU) processor or a multi-core/multi-CPU processor. For simplicity, processor 110 is shown to have one or more CPUs 112 (labeled as “CPU0” in FIG. 1) and processor 120 is shown to have one or more CPUs 122 (labeled as “CPU1” in FIG. 1). Each of processors 110 and 120 may also include a number of local memories. In the example illustrated in FIG. 1, processor 110 is shown to have multiple local memories 114 and processor 120 is shown to have multiple local memories 124. Local memories 114 and local memories 124 can store data for quick access by CPU0 and CPU1, respectively. Moreover, for coherency, a copy of data stored in a given local memory of one processor may also be stored in a given local memory of another processor.

Each of processors 110 and 120 may be communicatively connected to a local memory coherent interconnect circuit 130 via respective snoop ports. In the example illustrated in FIG. 1, processor 110 is connected to local memory coherent interconnect circuit 130 via snoop ports S0 and S1, and processor 120 is connected to local memory coherent interconnect circuit 130 via snoop ports S2, S3, S4 and S5. Thus, local memories 114 of processor 110 may be accessed and/or snooped via snoop ports S0 and/or S1. Similarly, local memories 124 of processor 120 may be accessed and/or snooped via snoop ports S2, S3, S4 and/or S5.

Local memory coherent interconnect circuit 130 may include a snoop filter 140. Under scheme 100, snoop filter 140 may maintain a vector record of which processor(s) having which local memory line(s) (e.g., cache lines) at processor level. For illustrative purposes and without limitation, in FIG. 1 local memories 114 of processor 110 are shown to have local memory lines 8000, 8001, 9002, 9003, A008 and A009, and local memories 124 of processor 120 are shown to have local memory lines 8000, 8001, 8002, 8003 and 9003. Accordingly, the record maintained by snoop filter 140 indicates that processor 110 has local memory lines 8000, 8001, 9002, 9003, A008 and A009 with “1” under the column “C0” (representative of CPU0 of processor 110) for each of those local memory lines and with “0” for the other local memory lines. Similarly, the record maintained by snoop filter 140 indicates that processor 120 has local memory lines 8000, 8001, 8002, 8003 and 9003 with “1” under the column “C1” (representative of CPU1 of processor 120) for each of those local memory lines and with “0” for the other local memory lines. Thus, snoop filter 140 may record local memory line (e.g., cache line) information based on processors, or at processor level, and not based on snoop ports. Advantageously, the number of bits of bit vector is reduced to the number of processors compared to conventional approaches in which the number of bits of bit vector corresponds to the number of snoop ports. In the example shown in FIG. 1, the number of bits of bit vector is 2 as there are two processors (processors 110 and 120), despite that there are six snoop ports (S0, S1, S2, S3, S4 and S5).

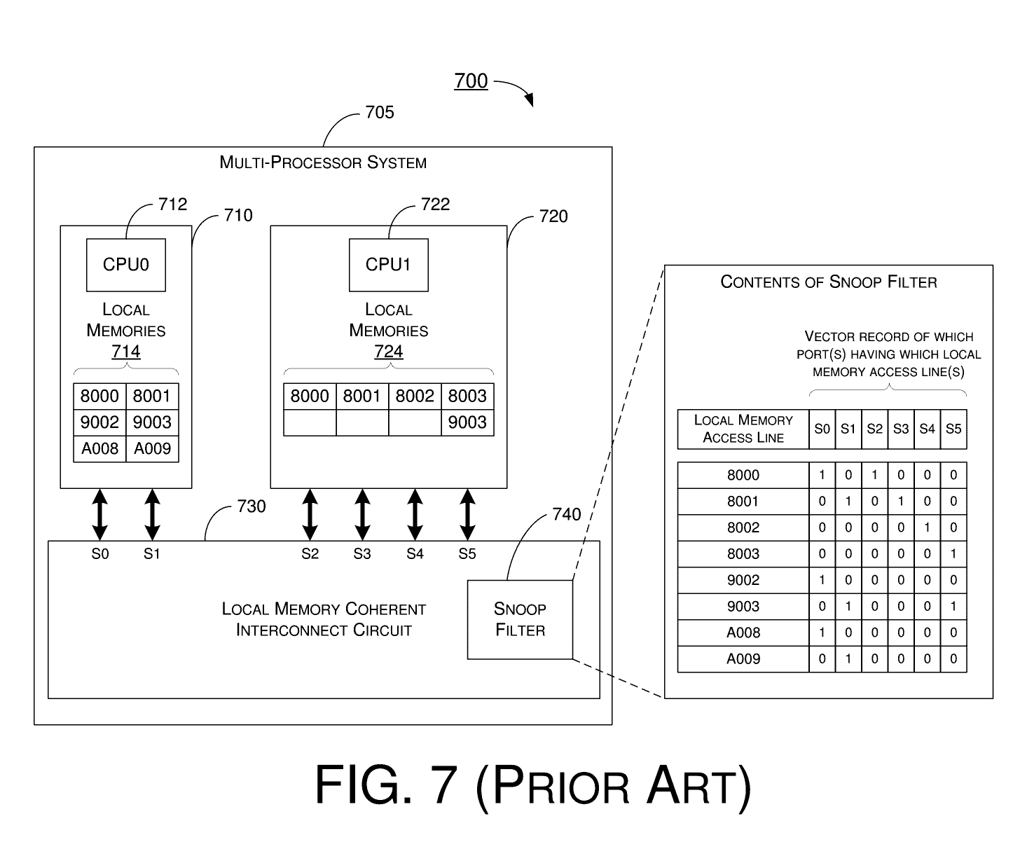

In contrast, FIG. 7 illustrates snoop filtering for a multi-port multi-processor system 705 under a conventional approach 700. Multi-port multi-processor system 705 includes multiple processors, including processors 710 and 720. Each of processors 710 and 720 is either a single-core/single-CPU processor or a multi-core/multi-CPU processor. Processors 710 has one or more CPU 712 (labeled as “CPU0” in FIG. 7) and processor 720 has one or more CPUs 722 (labeled as “CPU1” in FIG. 7). Processor 710 has multiple local memories 714 and processor 720 has multiple local memories 724.

Each of processors 710 and 720 is communicatively connected to a local memory coherent interconnect circuit 730 via respective snoop ports. In the example illustrated in FIG. 7, processor 710 is connected to local memory coherent interconnect circuit 730 via snoop ports S0 and S1, and processor 720 is connected to local memory coherent interconnect circuit 730 via snoop ports S2, S3, S4 and S5. Thus, local memories 714 of processor 710 can be accessed and/or snooped via snoop ports S0 and/or S1. Similarly, local memories 724 of processor 720 may be accessed and/or snooped via snoop ports S2, S3, S4 and/or S5.

Local memory coherent interconnect circuit 730 includes a snoop filter 740. Under conventional approach 700, snoop filter 740 maintains a vector record of which processor(s) having which local memory line(s) (e.g., cache lines) at port or interface level. In FIG. 7, local memories 714 of processor 710 are shown to have local memory lines 8000, 8001, 9002, 9003, A008 and A009, and local memories 724 of processor 720 are shown to have local memory lines 8000, 8001, 8002, 8003 and 9003. Accordingly, the record maintained by snoop filter 740 indicates that snoop port S0 is associated with local memory lines 8000, 9002 and A008 and that snoop port S1 is associated with local memory lines 8001, 9003 and A009 with “1” under columns “S0” and “S1”, respectively. The record maintained by snoop filter 740 indicates that snoop port S0 is not associated with local memory lines 8001, 8002, 8003, 9003 and A009 and that snoop port S1 is not associated with local memory lines 8000, 8002, 8003, 9002 and A008 with “0” under columns “S0” and “S1”, respectively. Similarly, the record maintained by snoop filter 740 indicates that snoop port S2 is associated with local memory line 8000, that snoop port S3 is associated with local memory line 8001, that snoop port S4 is associated with local memory line 8002, and that snoop port S5 is associated with local memory lines 8003 and 9003 with “1” under columns “S2”, “S3”, “S4” and “S5”, respectively. The record maintained by snoop filter 740 indicates that snoop port S2 is not associated with local memory lines 8001, 8002, 8003, 9002, 9003, A008 and A009, that snoop port S3 is not associated with local memory lines 8000, 8002, 8003, 9002, 0993, A008 and A009, that snoop port S4 is not associated with local memory lines 8000, 8001, 8003, 9002, 9003, A008 and A009, and that snoop port S5 is not associated with local memory lines 8000, 8001, 8002, 9002, A008 and A009 with “0” under columns “S2”, “S3”, “S4” and “S5”, respectively.

As can be seen, the number of bits of bit vector corresponds to the number of snoop ports, and redundant information is recorded in snoop filter 740 under conventional approach 700. This results in ineffective size of snoop filter 740 and inefficient usage of limited resources.

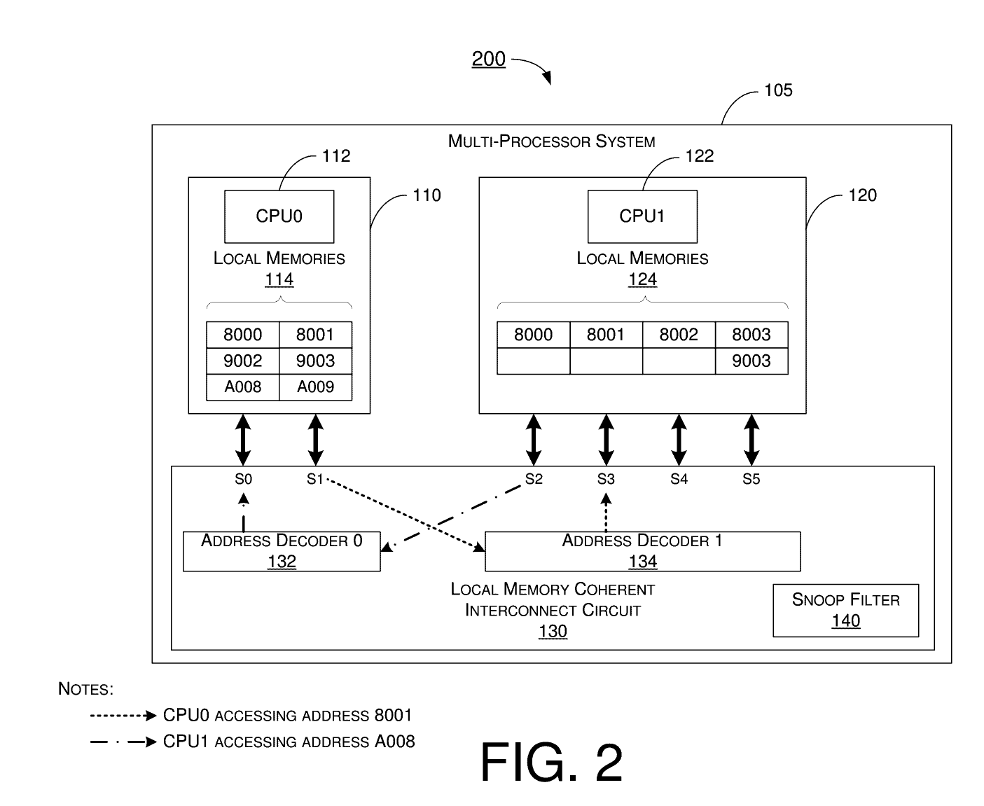

FIG. 2 illustrates an example scheme 200 of snooping for multi-port multi-processor system 105 in accordance with an implementation of the present disclosure. In the example shown in FIG. 2, local memory coherent interconnect circuit 130 of multi-port multi-processor system 105 may include one or more address decoders, such as address decoders 132 and 134 (labeled as “address decoder 0” and “address decoder 1” in FIG. 2).

Under scheme 200, when snooping, snoop port(s) belonging to a different processor or cache master may be snooped and snoop port(s) belonging to a same processor or cache master may not be snooped. In the example shown in FIG. 2, snoop routing between CPU1 and CPU0 (e.g., via snoop ports S2 and S0) may be allowed and achieved through address decoder 0. Similarly, snoop routing between CPU0 and CPU1 (e.g., via snoop ports S1 and S3) may be allowed and achieved through address decoder 1. On the other hand, snoop routing via snoop ports S0 and S1 may be prohibited, as snoop ports S0 and S1 belong to or otherwise are associated with CPU0 of processor 110. Likewise, snoop routing via any two snoop ports of snoop ports S2, S3, S4 and S5 may be prohibited, as snoop ports S2, S3, S4 and S5 belong to or otherwise are associated with CPU1 of processor 120. In some implementations, the snoop routing may be done in a round robin fashion.

Under scheme 200, when a CPU is configured to accept any snooping via any snoop port, the snooping may be routed to any of the ports belonging to or otherwise associated with that CPU. For example and without limitation, CPU0 may be configured to accept snooping via either of ports S0 and S1. Thus, snooping may be routed to either port S0 or port S1 when CPU0 accepts the snooping.

Under scheme 200, when a CPU is configured to receive snooping of certain address via a corresponding port, the snooping may be routed to the corresponding port with the aid of an address decoder. For example and without limitation, CPU1 may be configured to accept snooping of local memory line 8000 via port S2, snooping of local memory line 8001 via port S3, snooping of local memory line 8002 via port S4, and snooping of local memory lines 8003 and 9003 via port S5. Thus, depending on the address of which of ports S2, S3, S4 and S5 is indicated in a snooping request, address decoder 1 may route the snooping to CPU1 via the port the address of which is indicated in the request. In some implementations, a mapping between address and port may be done either by using a modulo result of interleaving (e.g., by any interleave mechanism known in the art) or by using a special hash table to associate each of the addresses to a respective one of the plurality of snoop ports.

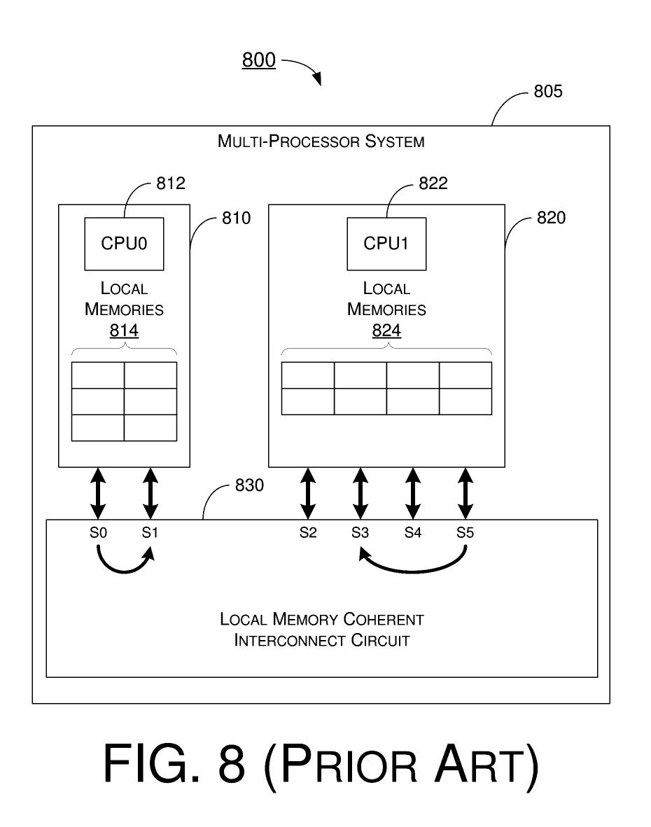

In contrast, FIG. 8 illustrates snooping for a multi-port multi-processor system 805 under a conventional approach 800. Multi-port multi-processor system 805 includes multiple processors, including processors 810 and 820. Each of processors 810 and 820 is either a single-core/single-CPU processor or a multi-core/multi-CPU processor. Processors 810 has one or more CPU 812 (labeled as “CPU0” in FIG. 8) and processor 820 has one or more CPUs 822 (labeled as “CPU1” in FIG. 8). Processor 810 has multiple local memories 814 and processor 820 has multiple local memories 824.

Each of processors 810 and 820 is communicatively connected to a local memory coherent interconnect circuit 830 via respective snoop ports. In the example illustrated in FIG. 8, processor 810 is connected to local memory coherent interconnect circuit 830 via snoop ports S0 and S1, and processor 820 is connected to local memory coherent interconnect circuit 830 via snoop ports S2, S3, S4 and S5. Thus, local memories 814 of processor 810 can be accessed and/or snooped via snoop ports S0 and/or S1. Similarly, local memories 824 of processor 820 may be accessed and/or snooped via snoop ports S2, S3, S4 and/or S5.

Under conventional approach 800, local memory coherent interconnect circuit 830 treats each interface or snoop port as an individual cache master. That is, intra-processor snooping is allowed. For example, as shown in FIG. 8, snooping between snoop ports S0 and S1 and between any two ports of snoop ports S2, S3, S4 and S5 would be allowed. However, intra-processor snooping is redundant and redundant snooping results in waste in power consumption and performance.

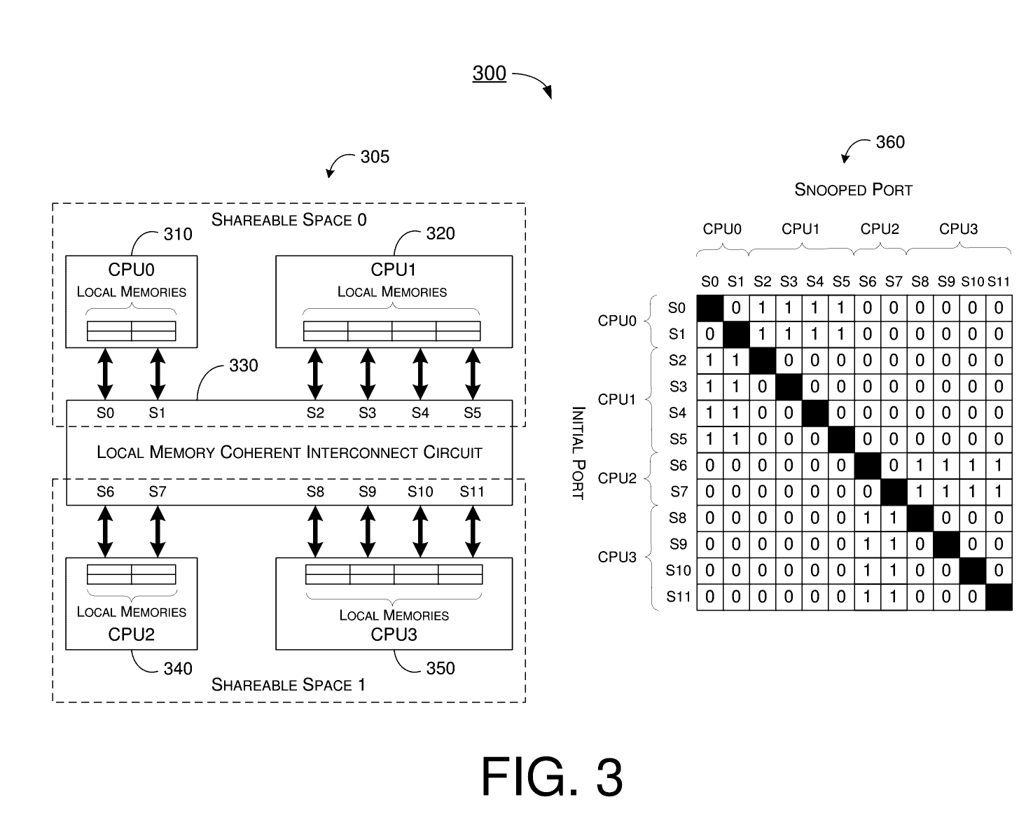

FIG. 3 illustrates an example scheme 300 of snooping for a multi-port multi-processor system 305 in accordance with another implementation of the present disclosure. Multi-port multi-processor system 305 may include multiple processors, including processors 310, 320, 340 and 350. Each of processors 310, 320, 340 and 350 may be a single-core/single-CPU processor or a multi-core/multi-CPU processor. For simplicity, processor 310 is shown to have one or more CPUs (labeled as “CPU0” in FIG. 3), processor 320 is shown to have one or more CPUs (labeled as “CPU1” in FIG. 3), processor 340 is shown to have one or more CPUs (labeled as “CPU2” in FIG. 3), and processor 350 is shown to have one or more CPUs (labeled as “CPU3” in FIG. 3). Each of processors 310, 320, 340 and 350 may also include a number of local memories that can store data for quick access by CPU0, CPU1, CPU2 and CPU3, respectively. For coherency, a copy of data stored in a given local memory of one processor may also be stored in a given local memory of another processor.

Each of processors 310, 320, 340 and 350 may be communicatively connected to a local memory coherent interconnect circuit 330 via respective snoop ports. In the example illustrated in FIG. 3, processor 310 is connected to local memory coherent interconnect circuit 330 via snoop ports S0 and S1, processor 320 is connected to local memory coherent interconnect circuit 330 via snoop ports S2, S3, S4 and S5, processor 340 is connected to local memory coherent interconnect circuit 330 via snoop ports S6 and S7, and processor 350 is connected to local memory coherent interconnect circuit 330 via snoop ports S8, S9, S10 and S11. Thus, any local memory of local memories of processors 310, 320, 340 and 350 may be accessed and/or snooped via one or more of snoop ports S0-S11, respectively.

Under scheme 300, a number of processors may be grouped into and belong to a respective shareable space. In the example shown in FIG. 3, processors 310 and 320 belong to shareable space 0, and processors 340 and 350 belong to shareable space 1. Accordingly, snooping not only may be between any two processors or cache masters, but also may be between any two processors or cache masters belonging to the same shareable space. In some implementations, one processor may snoop another processor in the same shareable space but may not snoop another processor in a different shareable space. For example and without limitation, in some implementations, snooping between CPU0 of processor 310 and CPU1 of processor 320 may be allowed, and snooping between CPU2 of processor 340 and CPU3 of processor 350 may also be allowed. However, snooping between CPU0 of processor 310 and CPU2 of processor 340 or CPU3 of processor 350 may not be allowed. Similarly, snooping between CPU1 of processor 320 and CPU2 of processor 340 or CPU3 of processor 350 may not be allowed.

In some implementations, the snooping relationship among processors or cache masters may be defined in a snooping table. In the example shown in FIG. 3, a snooping table 360 may be created, established or otherwise maintained to define the snooping relationship between CPU0 of processor 310, CPU1 of processor 320, CPU2 of processor 340 and CPU3 of processor 350. In snooping table 360, value “1” indicates that snooping via two snooping ports associated with two corresponding CPUs/processors is allowed, and value “0” indicates that snooping via two snooping ports associated with two corresponding CPUs/processors is not allowed. As shown in snooping table 360, snooping between ports S0 and S1 of CPU0 and ports S2, S3, S4 and S5 of CPU1 is allowed. Similarly, snooping between ports S6 and S7 of CPU2 and ports S8, S9, S10 and S11 of CPU3 is allowed.

### Illustrative Implementations

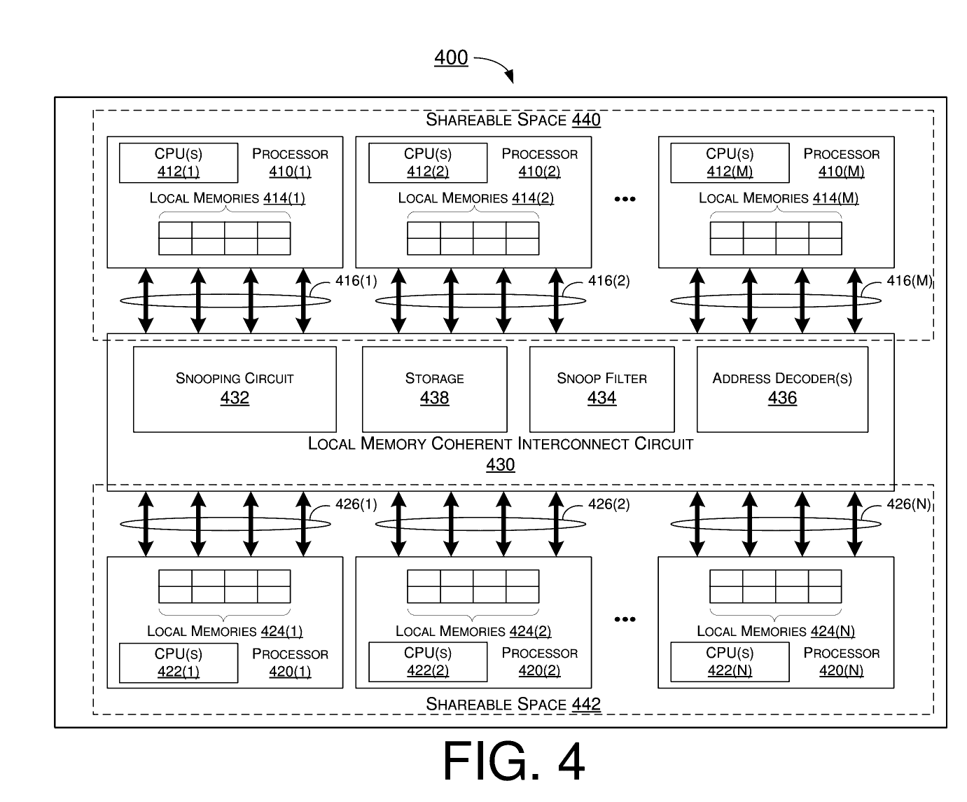

FIG. 4 illustrates an example apparatus 400 in accordance with an implementation of the present disclosure. Apparatus 400 may perform various functions to implement schemes, techniques, processes and methods described herein for memory coherence management with a snoop mechanism and snoop filter structure for multi-port processors, such as those described above with respect to scheme 100, scheme 200 and scheme 300 well as process 500 and process 600 described below. Apparatus 400 may be a part of an electronic apparatus, which may be a computing apparatus, a portable or mobile apparatus, or a wearable apparatus. For instance, apparatus 400 may be implemented in or as a smartphone, a smartwatch, a smart bracelet, a smart necklace, a personal digital assistant, or a computing device such as a tablet computer, a laptop computer, a notebook computer, a desktop computer, or a server. Apparatus 400 may include at least those components shown in FIG. 4, such as a local memory coherent interconnect circuit 430, at least a first set of processors 410(1)-410(M), with M being a positive integer greater than 1, and snoop ports 416(1)-416(M). The first set of processors 410(1)-410(M) are communicatively connected to local memory coherent interconnect circuit 430 via snoop ports 416(1)-416(M). Similarly, one or more of the local memories of a given processor of the first set of processors 410(1)-410(M) may be accessed and/or snooped via one or more snoop ports of snoop ports 416(1)-416(M).

Each processor of the first set of processors 410(1)-410(M) may be a single-core/multi-CPU processor or a multi-core/multi-CPU processor. That is, each processor of the first set of processors 410(1)-410(M) may respectively have one or more CPUs. In FIG. 4, processors 410(1)-410(M) are shown to have CPUs 412(1)-412(M), respectively. Moreover, each processor of the first set of processors 410(1)-410(M) may respective have a number of local memories. In FIG. 4, the first set of processors 410(1)-410(M) are shown to have a first set of local memories 414(1)-414(M), respectively. The local memories 414(1)-414(M) may be, for example and without limitation, caches, SRAMs and/or any other memories suitable for implementations in accordance with the present disclosure. Each of CPUs 412(1)-412(M) may be configured to utilize local memories 414(1)-414(M), respectively, to store instructions and data therein. That is, local memories 414(1)-414(M) may store data for quick access by CPUs 412(1)-412(M), respectively, and, for coherency, a copy of data stored in a given local memory of one processor may also be stored in a given local memory of another processor. This reduces the cost in terms of time and power consumption in accessing data from a main memory (not shown).

Local memory coherent interconnect circuit 430 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, local memory coherent interconnect circuit 430 is a special-purpose hardware specifically designed, built and configured to perform, execute or otherwise carry out specialized algorithms, software instructions, computations and logics to render or otherwise effect memory coherence management with a snoop mechanism and snoop filter structure for multi-port processors in accordance with the present disclosure.

Local memory coherent interconnect circuit 430 may include special-purpose electronic circuitry including a snooping circuit 432, a snoop filter 434, one or more address decoders 436, and a storage 438. Although depicted as individual components of local memory coherent interconnect circuit 430, some or all of snooping circuit 432, snoop filter 434, the one or more address decoders 436 and storage 438 may be implemented in a single piece of hardware such as an electronic circuit or an integrated-circuit (IC) chip.

Under the proposed scheme, local memory coherent interconnect circuit 430 may perform a number of operations in accordance with the present disclosure. For instance, snoop filter 434 of local memory coherent interconnect circuit 430 may maintain a record of local memory line information (e.g., information transmitted through snoop ports 416(1)-416(M)) at a processor level by associating each of local memories 414(1)-414(M) to each of processors 410(1)-410(M). That is, snoop filter 434 may associate local memories 414(1) to processor 410(1), local memories 414(2) to processor 410(2), and so on, up to associating local memories 414(M) to processor 410(M). Snoop filter 434 may also record all line status of local memories that are connected to snoop filter 434 (e.g., local memories 414(1)-414(M)).

Under the proposed scheme, when local memory coherent interconnect circuit 430 receives a request from any of the first set of processors 410(1)-410(M), snoop filter 434 may filter the request based on the record to determine whether the request pertains to any one of the local memories 414(1)-414(M) or none of them. Depending on to which local memory the request pertains, snooping circuit 432 may perform one of a number of acts and/or operations. Firstly, snooping circuit 432 may snoop at least one of the snoop ports of one of processors 410(1)-410(M) in response to determining that the request pertains to one of the respective local memories of that processor. For example and without limitation, upon receiving a request from processor 410(1) and determining that the request pertains to one of the local memories 414(2) of processor 410(2), snooping circuit 432 may snoop at least one of the snoop ports 416(2) of processor 410(2) in response to determining that the request from processor 410(1) pertains to one of the local memories 414(2) of processor 410(2). Secondly, snooping circuit 432 may ignore snooping of a processor in response to determining that the request does not pertain to any one of the local memories of the processor from which the request is received. For example and without limitation, upon receiving a request from processor 410(1) and determining that the request does not pertain to any one of the local memories 414(2) of processor 410(2), snooping circuit 432 may ignore the snooping and, hence, would not snoop processor 410(2). Thirdly and optionally, snooping circuit 432 may snoop at least one of one or more snoop ports of the processor from which the request is received in response to determining that the request pertains to one of the local memories of that processor. For example and without limitation, upon receiving a request from processor 410(1) and determining that the request pertains to one of the local memories 414(1) of processor 410(1), snooping circuit 432 may snoop at least one of snoop ports 416(1) of processor 410(1) in response to determining that the request pertains to one of the local memories 414(1) of processor 410(1).

In some implementations, apparatus 400 may also include a second set of processors 420(1)-420(N), with N being a positive integer greater than 1, and snoop ports 426(1)-426(N). The second set of processors 420(1)-420(N) are communicatively connected to local memory coherent interconnect circuit 430 via snoop ports 426(1)-426(N). Similarly, one or more of the local memories of a given processor of the second set of processors 420(1)-420(N) may be accessed and/or snooped via snoop ports 426(1)-426(N).

Each processor of the second set of processors 420(1)-420(N) may be a single-core/multi-CPU processor or a multi-core/multi-CPU processor. That is, each processor of the second set of processors 420(1)-420(N) may respectively have one or more CPUs. In FIG. 4, processors 420(1)-420(N) are shown to have CPUs 422(1)-422(N), respectively. Moreover, each processor of the second set of processors 420(1)-420(N) may respective have a number of local memories. In FIG. 4, the second set of processors 420(1)-420(N) are shown to have a second set of local memories 424(1)-424(N), respectively. The local memories 424(1)-424(N) may be, for example and without limitation, caches, SRAMs and/or any other memories suitable for implementations in accordance with the present disclosure. Each of CPUs 422(1)-422(N) may be configured to utilize local memories 424(1)-424(N), respectively, to store instructions and data therein.

In some implementations, local memory coherent interconnect circuit 430 may also maintain a snooping table (e.g., one similar to snooping table 360 of FIG. 3) with the snooping table stored in storage 438. The snooping table may define snoop routing among the first set of processors 410(1)-410(M) and the second set of processors 420(1)-420(N) in a way that snoop routing between any two processors belonging to a same shareable space is allowed and that snoop routing between any two processors belonging to different shareable spaces is not allowed. Accordingly, snooping circuit 432 of local memory coherent interconnect circuit 430 may snoop based on the snooping table. For example and without limitation, processors of the first set of processors 410(1)-410(M) may belong to a first shareable space 440, and processors of the second set of processors 420(1)-420(N) may belong to a second shareable space 442 which is different from the first shareable space 440. In such cases, snooping circuit 432 may allow snoop routing between any two processors of the first set of processors 410(1)-410(M) (e.g., processors 410(1) and 410(2)) or between any two processors of the second set of processors 420(1)-420(N) (e.g., processors 420(1) and 420(2)). However, snooping circuit 432 may prohibit snoop routing between any a processor of the first set of processors 410(1)-410(M) and a processor of the second set of processors 420(1)-420(N), since the first set of processors 410(1)-410(M) and the second set of processors 420(1)-420(N) belong to different shareable spaces 440 and 442. In some implementations, the snoop routing may be done in a round robin fashion.

In some implementations, at least one processor of either or both of the first set of processors 410(1)-410(M) and the second set of processors 420(1)-420(N) may be a multi-port processor with a plurality of snoop ports connected to local memory coherent interconnect circuit 430. This multi-port processor (e.g., processor 410(1), 410(2), 420(1) or 420(2)) may accept snooping via any of the plurality of snoop ports. In some implementations, in snooping the snoop ports of this multi-port processor, local memory coherent interconnect circuit 430 may route the snooping to any one of the plurality of snoop ports of this multi-port processor regardless of an address of one of the local memories that is indicated in the request. For example and without limitation, processor 410(2) may be a multi-port processor having multiple snoop ports 416(2) connected to local memory coherent interconnect circuit 430. Upon receiving a request, and snooping circuit 432 may route snooping to any one of the multiple snoop ports 416(2) of processor 410(2) irrespective of an address of a local memory among local memories 414(2) that is indicated in the request.

Alternatively, in snooping the snoop ports of the multi-port processor, local memory coherent interconnect circuit 430 may perform a number of operations in lieu of routing the snooping to any one of the plurality of snoop ports of the multi-port processor. Specifically, the one or more address decoders 436 may identify an address of one of the plurality of local memories of the multi-port processor that is indicated in the request. Moreover, the one or more address decoders 436 may determine one of the plurality of snoop ports of the multi-port processor as being associated with the identified address by mapping the plurality of snoop ports of the multi-port processor to addresses of the plurality of local memories of the multi-port processor, either by using a modulo result of interleaving (e.g., by any interleave mechanism known in the art) or by using a special hash table to associate each of the addresses to a respective one of the plurality of snoop ports. Furthermore, snooping circuit 432 may route the snooping to the determined one of the plurality of snoop ports of the multi-port processor based on a result of the determination by the one or more address decoders 436. For example and without limitation, processor 420(2) may be a multi-port processor having multiple snoop ports 426(2) connected to local memory coherent interconnect circuit 430. Upon receiving a request, the one or more address decoders 436 may identify an address of one of the local memories 424(2) of processor 420(2) that is indicated in the request. Moreover, the one or more address decoders 436 may determine one of the snoop ports 426(2) of processor 420(2) as being associated with the identified address by mapping the snoop ports 426(2) of processor 420(2) to addresses of local memories 424(2) of processor 420(2), either by using a modulo result of interleaving (e.g., by any interleave mechanism known in the art) or by using a special hash table to associate each of the addresses to a respective one of the plurality of snoop ports. Furthermore, the one or more address decoders 436 may route the snooping to the determined one of the snoop ports 426(2) of processor 420(2) based on a result of the determination.

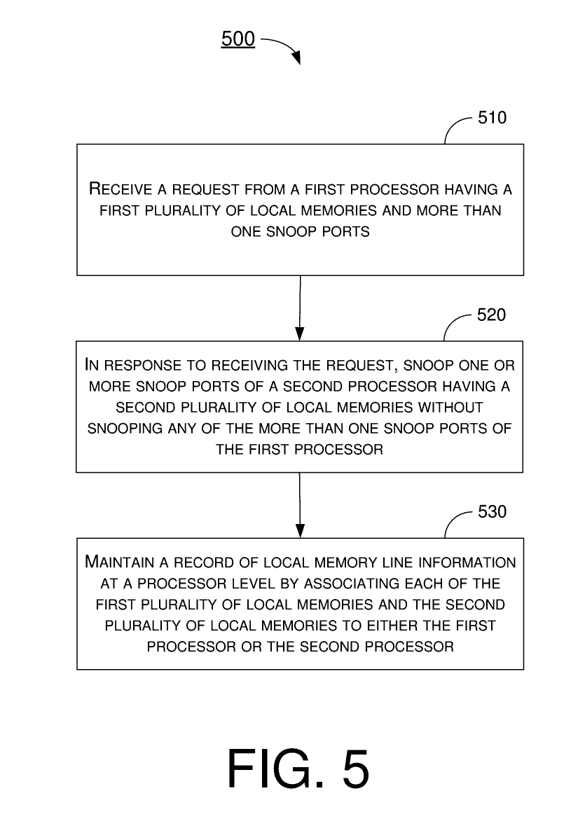

FIG. 5 illustrates an example process 500 in accordance with an implementation of the present disclosure. Process 500 may be an example implementation of schemes, techniques, processes and methods described herein for memory coherence management with a snoop mechanism and snoop filter structure for multi-port processors, such as those described above with respect to scheme 100, scheme 200 and scheme 300, whether partially or completely. Process 500 may represent an aspect of implementation of features of apparatus 400. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively in a different order. Process 500 may be implemented by apparatus 400. Solely for illustrative purposes and without limitation, process 500 is described below in the context of apparatus 400. Process 500 may begin at block 510.

At 510, process 500 may involve local memory coherent interconnect circuit 430 of apparatus 400 receiving a request from a first processor having a first plurality of local memories and more than one snoop ports. Process 500 may proceed from 510 to 520.

At 520, process 500 may involve local memory coherent interconnect circuit 430 of apparatus 400, in response to receiving the request, snooping one or more snoop ports of a second processor having a second plurality of local memories without snooping any of the more than one snoop ports of the first processor. Process 500 may proceed from 520 to 530.

At 530, process 500 may involve local memory coherent interconnect circuit 430 of apparatus 400 maintaining a record of local memory line information at a processor level by associating each of the first plurality of local memories and the second plurality of local memories to either the first processor or the second processor.

In some implementations, in snooping the one or more snoop ports of the second processor without snooping any of the more than one snoop ports of the first processor, process 500 may involve local memory coherent interconnect circuit 430 of apparatus 400 performing any of a number of operations. For instance, process 500 may involve snoop filter 434 filtering the request based on the record to determine whether the request pertains to one of the second plurality of local memories. Alternatively or additionally, process 500 may involve snooping circuit 432 snooping at least one of the one or more snoop ports of the second processor in response to determining that the request pertains to one of the second plurality of local memories. Alternatively or additionally, process 500 may involve snooping circuit 432 ignoring the snooping of the second processor in response to determining that the request does not pertain to any one of the second plurality of local memories.

In some implementations, the second processor may include a multi-port processor with a plurality of snoop ports connected to a local memory coherent interconnect circuit. The second processor may be configured to accept the snooping via any of the plurality of snoop ports. In such cases, in snooping the one or more snoop ports of the second processor, process 500 may involve local memory coherent interconnect circuit 430 routing the snooping to one of the plurality of snoop ports of the second processor (e.g., in a round robin fashion) regardless of an address of one of the second plurality of local memories that is indicated in the request.

In some implementations, the second processor may include a multi-port processor with a plurality of snoop ports connected to a local memory coherent interconnect circuit. The second processor may be configured to accept the snooping via one of the plurality of snoop ports for respective one or more addresses of one or more of the second plurality of local memories. In such cases, in snooping the one or more snoop ports of the second processor, process 500 may involve the one or more address decoders 436 identifying an address of one of the second plurality of local memories that is indicated in the request. Moreover, process 500 may involve the one or more address decoders 436 determining one of the plurality of snoop ports of the second processor as being associated with the identified address. Furthermore, process 500 may involve the one or more address decoders 436 routing the snooping to the determined one of the plurality of snoop ports based on a result of the determining.

In some implementations, in determining the one of the plurality of snoop ports of the second processor as being associated with the identified address, process 500 may involve the one or more address decoders 436 mapping the plurality of snoop ports of the second processor to addresses of the second plurality of local memories either by using a modulo result of interleaving (e.g., by any interleave mechanism known in the art) or by using a special hash table to associate each of the addresses to a respective one of the plurality of snoop ports.

In some implementations, in snooping the one or more snoop ports of the second processor without snooping any of the more than one snoop ports of the first processor, process 500 may involve snooping circuit 432 snooping the one or more snoop ports of the second processor without snooping any of the more than one snoop ports of the first processor, any of one or more snoop ports of a third processor, or any of one or more snoop ports of a fourth processor. The third processor may have a third plurality of local memories and the fourth processor may have a fourth plurality of local memories. Each of the first processor, the second processor, the third processor and the fourth processor may have at least one snoop port connected to a local memory coherent interconnect circuit.

In some implementations, in snooping the one or more snoop ports of the second processor without snooping any of the more than one snoop ports of the first processor, any of the one or more snoop ports of the third processor, or any of the one or more snoop ports of the fourth processor, process 500 may involve snooping circuit 432 maintaining a snooping table that defines snoop routing among the first processor, the second processor, the third processor, and the fourth processor in a way that snoop routing between any two processors belonging to a same shareable space is allowed and that snoop routing between any two processors belonging to different shareable spaces is not allowed. In such cases, the snooping may involve snooping based on the snooping table. The first processor and the second processor may belong to a first shareable space, while the third processor and the fourth processor may belong to a second shareable space different from the first shareable space.

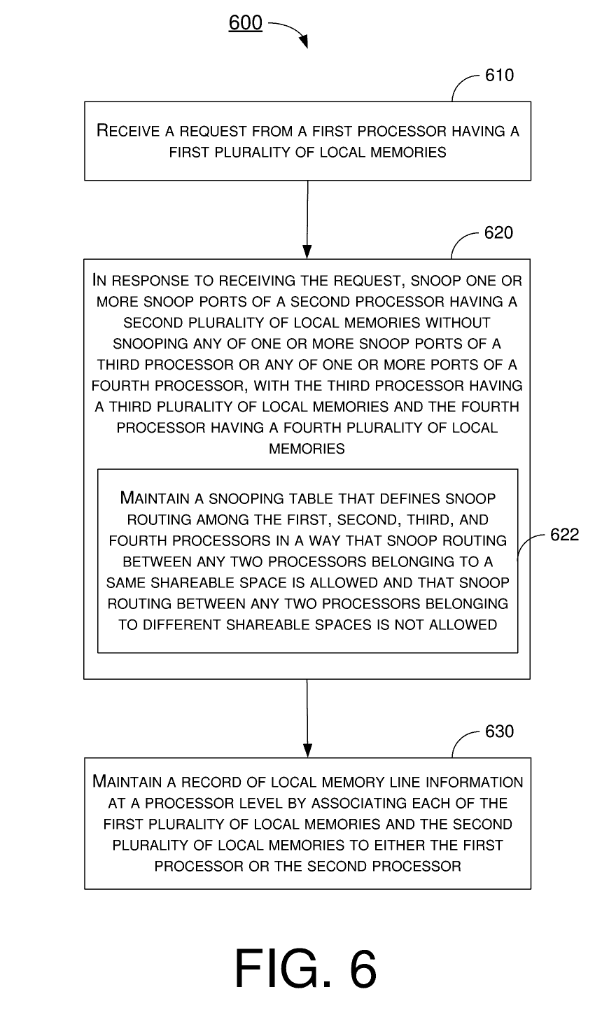

FIG. 6 illustrates an example process 600 in accordance with an implementation of the present disclosure. Process 600 may be an example implementation of schemes, techniques, processes and methods described herein for memory coherence management with a snoop mechanism and snoop filter structure for multi-port processors, such as those described above with respect to scheme 100, scheme 200 and scheme 300, whether partially or completely. Process 600 may represent an aspect of implementation of features of apparatus 400. Process 600 may include one or more operations, actions, or functions as illustrated by one or more of blocks 610, 620 and 630, as well as sub-block 622. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively in a different order. Process 600 may be implemented by apparatus 400. Solely for illustrative purposes and without limitation, process 600 is described below in the context of apparatus 400. Process 600 may begin at block 610.

At 610, process 600 may involve local memory coherent interconnect circuit 430 of apparatus 400 receiving a request from a first processor having a first plurality of local memories. Process 600 may proceed from 610 to 620.

At 620, process 600 may involve local memory coherent interconnect circuit 430 of apparatus 400, in response to the request, snooping one or more snoop ports of a second processor having a second plurality of local memories without snooping any of one or more snoop ports of a third processor or any of one or more snoop ports of a fourth processor. The third processor may have a third plurality of local memories and the fourth processor may have a fourth plurality of local memories. Each of the first processor, the second processor, the third processor and the fourth processor may have at least one snoop port connected to a local memory coherent interconnect circuit. In some implementations, as shown in sub-block 622, in snooping the one or more snoop ports of the second processor without snooping any of the one or more snoop ports of the third processor or any of the one or more snoop ports of the fourth processor, process 600 may involve snooping circuit 432 maintaining a snooping table that defines snoop routing among the first processor, the second processor, the third processor, and the fourth processor in a way that snoop routing between any two processors belonging to a same shareable space is allowed and that snoop routing between any two processors belonging to different shareable spaces is not allowed. The snooping may be based on the snooping table. The first processor and the second processor may belong to a first shareable space, while the third processor and the fourth processor may belong to a second shareable space different from the first shareable space. Process 600 may proceed from 620 to 630.

At 630, process 600 may involve local memory coherent interconnect circuit 430 of apparatus 400 maintaining a record of local memory line information at a processor level by associating each of the first plurality of local memories and the second plurality of local memories to either the first processor or the second processor.

In some implementations, in snooping the one or more snoop ports of the second processor, process 600 may involve snoop filter 434 filtering the request based on the record to determine whether the request pertains to one of the second plurality of local memories. Alternatively or additionally, process 600 may involve snooping circuit 432 snooping at least one of the one or more snoop ports of the second processor in response to determining that the request pertains to one of the second plurality of local memories. Alternatively or additionally, process 600 may involve snooping circuit 432 ignoring snooping of the second processor in response to determining that the request does not pertain to any one of the second plurality of local memories.

Alternatively, in snooping the one or more snoop ports of the second processor, process 600 may involve snoop filter 434 filtering the request based on the record to determine whether the request pertains to one of the first plurality of local memories or one of the second plurality of local memories. Alternatively or additionally, process 600 may involve snooping circuit 432 snooping at least one of the one or more snoop ports of the second processor in response to determining that the request pertains to one of the second plurality of local memories. Alternatively or additionally, process 600 may involve snooping circuit 432 snooping at least one of one or more snoop ports of the first processor in response to determining that the request pertains to one of the first plurality of local memories. Alternatively or additionally, process 600 may involve snooping circuit 432 ignoring snooping of the second processor or the first processor in response to determining that the request does not pertain to any one of the second plurality of local memories or any one of the first plurality of local memories.

In some implementations, the second processor may include a multi-port processor with a plurality of snoop ports connected to a local memory coherent interconnect circuit. The second processor may be configured to accept the snooping via any of the plurality of snoop ports. In such cases, in snooping the one or more snoop ports of the second processor, process 600 may involve snooping circuit 432 routing the snooping to one of the plurality of snoop ports of the second processor (e.g., in a round robin fashion) regardless of an address of one of the second plurality of local memories that is indicated in the request.

In some implementations, the second processor may include a multi-port processor with a plurality of snoop ports connected to a local memory coherent interconnect circuit. The second processor may be configured to accept the snooping via one of the plurality of snoop ports for respective one or more addresses of one or more of the second plurality of local memories. In such cases, in snooping the one or more snoop ports of the second processor, process 600 may involve the one or more address decoders 436 identifying an address of one of the second plurality of local memories that is indicated in the request. Additionally, process 600 may involve the one or more address decoders 436 determining one of the plurality of snoop ports of the second processor as being associated with the identified address. Moreover, process 600 may involve the one or more address decoders 436 routing the snooping to the determined one of the plurality of snoop ports based on a result of the determining.

In some implementations, in determining the one of the plurality of snoop ports of the second processor as being associated with the identified address, process 600 may involve the one or more address decoders 436 mapping the plurality of snoop ports of the second processor to addresses of the second plurality of local memories either by using a modulo result of interleaving (e.g., by any interleave mechanism known in the art) or by using a special hash table to associate each of the addresses to a respective one of the plurality of snoop ports.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving a request from a first processor having a first plurality of local memories and more than one snoop ports; and
responsive to the request, snooping one or more snoop ports of a second processor having a second plurality of local memories without snooping any of the more than one snoop ports of the first processor.

2. The method of claim 1, further comprising:
maintaining a record of local memory line information at a processor level by associating each of the first plurality of local memories and the second plurality of local memories to either the first processor or the second processor.

3. The method of claim 2, wherein the snooping of the one or more snoop ports of the second processor without snooping any of the more than one snoop ports of the first processor comprises:
filtering the request based on the record to determine whether the request pertains to one of the second plurality of local memories;
snooping at least one of the one or more snoop ports of the second processor in response to determining that the request pertains to one of the second plurality of local memories; or
ignoring snooping of the second processor in response to determining that the request does not pertain to any one of the second plurality of local memories.

4. The method of claim 1, wherein the second processor comprises a multi-port processor with a plurality of snoop ports connected to a local memory coherent interconnect circuit, wherein the second processor is configured to accept the snooping via any of the plurality of snoop ports, and wherein the snooping of the one or more snoop ports of the second processor comprises routing the snooping to one of the plurality of snoop ports of the second processor regardless of an address of one of the second plurality of local memories that is indicated in the request.

5. The method of claim 1, wherein the second processor comprises a multi-port processor with a plurality of snoop ports connected to a local memory coherent interconnect circuit, wherein the second processor is configured to accept the snooping via one of the plurality of snoop ports for respective one or more addresses of one or more of the second plurality of local memories, and wherein the snooping of the one or more snoop ports of the second processor comprises:
identifying an address of one of the second plurality of local memories that is indicated in the request;
determining one of the plurality of snoop ports of the second processor as being associated with the identified address; and
routing the snooping to the determined one of the plurality of snoop ports based on a result of the determining.

6. The method of claim 5, wherein the determining of the one of the plurality of snoop ports of the second processor as being associated with the identified address comprises mapping the plurality of snoop ports of the second processor to addresses of the second plurality of local memories either by using a modulo result of interleaving or by using a hash table to associate each of the addresses to a respective one of the plurality of snoop ports.

7. The method of claim 1, wherein the snooping of the one or more snoop ports of the second processor without snooping any of the more than one snoop ports of the first processor comprises:
snooping the one or more snoop ports of the second processor without snooping any of the more than one snoop ports of the first processor, any of one or more snoop ports of a third processor, or any of one or more snoop ports of a fourth processor,
wherein the third processor has a third plurality of local memories and the fourth processor has a fourth plurality of local memories, and
wherein each of the first processor, the second processor, the third processor and the fourth processor has at least one snoop port connected to a local memory coherent interconnect circuit.

8. The method of claim 7, wherein the snooping of the one or more snoop ports of the second processor without snooping any of the more than one snoop ports of the first processor, any of the one or more snoop ports of the third processor, or any of the one or more snoop ports of the fourth processor comprises:
maintaining a snooping table that defines snoop routing among the first processor, the second processor, the third processor, and the fourth processor in a way that snoop routing between two processors belonging to a same shareable space is allowed and that snoop routing between two processors belonging to different shareable spaces is not allowed,
wherein the snooping comprises snooping based on the snooping table,
wherein the first processor and the second processor belong to a first shareable space, and
wherein the third processor and the fourth processor belong to a second shareable space different from the first shareable space.

9. A method, comprising:
receiving a request from a first processor having a first plurality of local memories; and
responsive to the request, snooping one or more snoop ports of a second processor having a second plurality of local memories without snooping any of one or more snoop ports of a third processor or any of one or more snoop ports of a fourth processor,
wherein the third processor has a third plurality of local memories and the fourth processor has a fourth plurality of local memories, and
wherein each of the first processor, the second processor, the third processor and the fourth processor has at least one snoop port connected to a local memory coherent interconnect circuit.

10. The method of claim 9, wherein the snooping of the one or more snoop ports of the second processor without snooping any of the one or more snoop ports of the third processor or any of the one or more snoop ports of the fourth processor comprises:
maintaining a snooping table that defines snoop routing among the first processor, the second processor, the third processor, and the fourth processor in a way that snoop routing between two processors belonging to a same shareable space is allowed and that snoop routing between two processors belonging to different shareable spaces is not allowed,
wherein the snooping comprises snooping based on the snooping table,
wherein the first processor and the second processor belong to a first shareable space, and
wherein the third processor and the fourth processor belong to a second shareable space different from the first shareable space.

11. The method of claim 9, further comprising:
maintaining a record of local memory line information at a processor level by associating each of the first plurality of local memories and the second plurality of local memories to either the first processor or the second processor.

12. The method of claim 11, wherein the snooping of the one or more snoop ports of the second processor comprises:
filtering the request based on the record to determine whether the request pertains to one of the second plurality of local memories;
snooping at least one of the one or more snoop ports of the second processor in response to determining that the request pertains to one of the second plurality of local memories; or
ignoring snooping of the second processor in response to determining that the request does not pertain to any one of the second plurality of local memories.

13. The method of claim 11, wherein the snooping of the one or more snoop ports of the second processor comprises:
filtering the request based on the record to determine whether the request pertains to one of the first plurality of local memories or one of the second plurality of local memories;
snooping at least one of the one or more snoop ports of the second processor in response to determining that the request pertains to one of the second plurality of local memories;
snooping at least one of one or more snoop ports of the first processor in response to determining that the request pertains to one of the first plurality of local memories; or
ignoring snooping of the second or first processor in response to determining that the request does not pertain to any one of the second or first plurality of local memories.

14. The method of claim 9, wherein the second processor comprises a multi-port processor with a plurality of snoop ports connected to the local memory coherent interconnect circuit, wherein the second processor is configured to accept the snooping via any of the plurality of snoop ports, and wherein the snooping of the one or more snoop ports of the second processor comprises routing the snooping to one of the plurality of snoop ports of the second processor regardless of an address of one of the second plurality of local memories that is indicated in the request.

15. The method of claim 9, wherein the second processor comprises a multi-port processor with a plurality of snoop ports connected to the local memory coherent interconnect circuit, wherein the second processor is configured to accept the snooping via one of the plurality of snoop ports for respective one or more addresses of one or more of the second plurality of local memories, and wherein the snooping of the one or more snoop ports of the second processor comprises:
identifying an address of one of the second plurality of local memories that is indicated in the request;
determining one of the plurality of snoop ports of the second processor as being associated with the identified address; and
routing the snooping to the determined one of the plurality of snoop ports based on a result of the determining.

16. The method of claim 15, wherein the determining of the one of the plurality of snoop ports of the second processor as being associated with the identified address comprises mapping the plurality of snoop ports of the second processor to addresses of the second plurality of local memories either by using a modulo result of interleaving or by using a hash table to associate each of the addresses to a respective one of the plurality of snoop ports.

17. An apparatus, comprising:
a local memory coherent interconnect circuit; and
a first plurality of processors including at least a first processor and a second processor,
wherein the first processor has a first plurality of local memories and the second processor has a second plurality of local memories,
wherein the first processor has more than one snoop ports, and
wherein the local memory coherent interconnect circuit is capable of performing acts comprising:
receiving a request from the first processor; and
responsive to the request, snooping one or more snoop ports of the second processor without snooping any of the more than one snoop ports of the first processor.

18. The apparatus of claim 17, wherein the local memory coherent interconnect circuit is further capable of performing acts comprising:
maintaining a record of local memory line information at a processor level by associating each of the first plurality of local memories and the second plurality of local memories to either the first processor or the second processor.

19. The apparatus of claim 18, wherein, in snooping the one or more snoop ports of the second processor without snooping any of the more than one snoop ports of the first processor, the local memory coherent interconnect circuit is capable of performing acts comprising:
filtering the request based on the record to determine whether the request pertains to one of the second plurality of local memories;
snooping at least one of the one or more snoop ports of the second processor in response to determining that the request pertains to one of the second plurality of local memories; or
ignoring snooping of the second processor in response to determining that the request does not pertain to any one of the second plurality of local memories.

20. The apparatus of claim 17, wherein the second processor comprises a multi-port processor with a plurality of snoop ports connected to the local memory coherent interconnect circuit, wherein the second processor is configured to accept the snooping via any of the plurality of snoop ports, and wherein, in snooping the one or more snoop ports of the second processor, the local memory coherent interconnect circuit is capable of routing the snooping to one of the plurality of snoop ports of the second processor regardless of an address of one of the second plurality of local memories that is indicated in the request.

21. The apparatus of claim 17, wherein the second processor comprises a multi-port processor with a plurality of snoop ports connected to the local memory coherent interconnect circuit, wherein the second processor is configured to accept the snooping via one of the plurality of snoop ports for respective one or more addresses of one or more of the second plurality of local memories, and wherein, in snooping the one or more snoop ports of the second processor, the local memory coherent interconnect circuit is capable of performing acts comprising:
identifying an address of one of the second plurality of local memories that is indicated in the request;
determining one of the plurality of snoop ports of the second processor as being associated with the identified address; and
routing the snooping to the determined one of the plurality of snoop ports based on a result of the determining.

22. The apparatus of claim 21, wherein, in determining the one of the plurality of snoop ports of the second processor as being associated with the identified address, the local memory coherent interconnect circuit is capable of mapping the plurality of snoop ports of the second processor to addresses of the second plurality of local memories either by using a modulo result of interleaving or by using a hash table to associate each of the addresses to a respective one of the plurality of snoop ports.

23. The apparatus of claim 17, further comprising:
a second plurality of processors including at least a third processor and a fourth processor,
wherein, in snooping the one or more snoop ports of the second processor without snooping any of the more than one snoop ports of the first processor, the local memory coherent interconnect circuit is capable of snooping the one or more snoop ports of the second processor without snooping any of the more than one snoop ports of the first processor, any of one or more snoop ports of the third processor, or any of one or more snoop ports of the fourth processor,
wherein the third processor has a third plurality of local memories and the fourth processor has a fourth plurality of local memories, and
wherein each of the first processor, the second processor, the third processor and the fourth processor has at least one snoop port connected to a local memory coherent interconnect circuit.

24. The apparatus of claim 23, wherein, in snooping the one or more snoop ports of the second processor without snooping any of the more than one snoop ports of the first processor, any of the one or more snoop ports of the third processor, or any of the one or more snoop ports of the fourth processor, the local memory coherent interconnect circuit is capable of maintaining a snooping table that defines snoop routing among the first processor, the second processor, the third processor, and the fourth processor in a way that snoop routing between two processors belonging to a same shareable space is allowed and that snoop routing between two processors belonging to different shareable spaces is not allowed, wherein the snooping comprises snooping based on the snooping table, wherein the first processor and the second processor belong to a first shareable space, and wherein the third processor and the fourth processor belong to a second shareable space different from the first shareable space.
